(19) United States
(12) Patent Application Publication
(10) Pub. No.: US 2009/0232028 A1
(43) Pub. Date: Sep. 17, 2009

(54) CONFIGURATION SYSTEMS AND METHODS FOR UTILIZING LOCATION INFORMATION TO CONFIGURE DEVICES IN APPLICATION SYSTEMS

(76) Inventors: Aaron Baalbergen, Miami, FL (US); Demian Martin, San Leandro, CA (US)

Correspondence Address: IPSG, P.C., P.O. BOX 700640, SAN JOSE, CA, 95170, US

(21) Appl. No.: 12/046,386

(22) Filed: Mar. 11, 2008

(51) Int. Cl. H04L 12/28

(52) U.S. Cl. 370/255

(57) ABSTRACT

A method for configuring at least one of a first device, a second device, and an application system is disclosed. The application system may be utilized in a spatial unit. The spatial unit may include a plurality of spatial subunits. The method may include determining a first spatial subunit in the spatial unit. The first spatial subunit may be related to the first device. The method may also include identifying, based on a result of the determining, a second device that is physically disposed in the first spatial subunit. The method may also include configuring the at least one of the first device, the second device, and the application system using at least a first rule, wherein the first rule may involve at least the first device and the second device.

### BACKGROUND OF THE INVENTION

The present invention relates to automation, such as one or more of home automation, small business automation, factory automation, etc. In general, an arrangement for automation may involve control and/or interworking of multiple devices, such as one or more phones, security control panels, sensors, media players, and/or remote control devices. Typically, prior art automation arrangements may have various problems, such as license conflicts and complexity, as illustrated and discussed with reference to the example of FIG. 1.

FIG. 1 shows a schematic representation an example design of an example prior art automation arrangement 100 (hereinafter “arrangement 100”). Arrangement 100 may include a phone 152, a security panel 156, a motion sensor 160, a remote control device 154 (hereinafter “remote control 154”), and a media player 158. As an example, in designing arrangement 100, it may be desirable to implement phone software 102 of phone 152 utilizing Asterisk® phone software, available from Digium, Inc. (www.digium.com and www.asterisk.org); it may also be desirable to implement media player software 118 of media player 158 utilizing xine media player software, available from the xine-Project (www.xinehq.de); it may also be desirable to implement motion sensor 160 utilizing the Z-Wave standard controlled by the Z-Wave Alliance (www.Z-Wave.com). However, because Asterisk® phone software and xine media player software are under the General Public License (GPL) while the Z-Wave is a proprietary protocol, there may be license conflicts that render the above design of arrangement 100 impractical, as further discussed below.

In arrangement 100, based on the above-mentioned design, phone 152 may be coupled with security panel 156 and remote control 154 through Asterisk® management interfaces 104, 128, and 112; and links 108 and 106. Each of interface 104, interface 128, interface 112, link 108, and link 106 may be implemented utilizing the Asterisk® protocol, which is under the GPL. Media player 158 may be coupled with security panel 156 and remote control 154 through xine control interfaces 120, 126, and 114; and links 122 and 116. Each of interface 126, interface 120, interface 114, link 122, and link 116 may be implemented utilizing the xine protocol, which is also under the GPL. Motion sensor 160 may be coupled with security panel 156 through a Z-Wave interface 136, a Z-Wave interface 130, and a link 132. Interface 136, interface 130, and link 132 may need to be implemented utilizing the Z-Wave protocol, which is proprietary.

As can be readily appreciated by one of ordinary skill in the art, the coexistence of Asterisk® management interface 128 and Z-Wave interface 130 in security panel 156 may violate the GPL of Asterisk® management interface 128 since Z-Wave interface 130 is not under the GPL. Similarly, the coexistence of xine control interface 126 and Z-Wave interface 130 in security panel 156 may also violate the GPL of xine control interface 126.

In order to resolve the license conflicts in security panel 156, Z-Wave interface 130 may need to be replaced with an interface that complies with the GPL. However, the GPL interface for coupling security panel 156 and motion sensor 160 may not exist or may not be desirable. Alternatively, a proprietary phone system may need to be implemented from the ground up to replace the Asterisk® phone software 102, such that Asterisk® management interface 128 may be replaced with a proprietary interface that is not under the GPL. However, the implementation of such a proprietary phone system may incur substantially high costs and therefore may be impractical. Similarly, implementing a new media player system for replacing xine control interface 126 in security panel 156 may also be costly and impractical. As a result, arrangement 100 may be extremely difficult and expensive, if not impossible, to implement.

Further, as also illustrated in the example of FIG. 1, at least three interfaces according to three different protocols need to be implemented in security panel 156; at least two interfaces according to two different protocols need to be implemented in remote control 154. More devices in arrangement 100 may require more interfaces to be implemented based on different protocols in many of the devices in arrangement 100. The implementation requirements and the complexity in arrangement 100 may result in tremendously high implementation, management, and maintenance costs for arrangement 100.

The invention may also relate to configuration of application systems, such as automation systems, security systems, home entertainment systems, etc., which may include a group of networked devices. In particular, the invention may relate to automatic-configuration systems and methods for automatically obtaining information concerning devices to add the device to application systems.

Typically, a conventional process for adding a device to an application system may require the user or administrator of the application system to manually install software (e.g., a driver) in a computer to enable the computer to find/recognize the device. The process may also require the user or system administrator to manually or semi-manually configure the device through the computer and/or a Web browser through multiple interactive steps. The process may be time-consuming. Further, if the user or system administrator does not have sufficient knowledge or information for configuring the device, the device may not be successfully or properly added to the system.

In addition, conventional methods for configuring devices in an application system may typically be limited to only configuring the intrinsic parameters of the devices and the parameters necessary for the devices to communicate with other devices in the system. The conventional methods may not take into account physical location information (or spatial information) pertaining to the operation of the devices, e.g., the rooms in a house where the devices and related devices are disposed. As a result, a user or technician may need to manually adapt the devices to the physical operating environment of the application system. However, the user or technician may not have sufficient information, knowledge, or experience to optimize the adaptation/configuration.

As an example, the location information pertaining to configuring a security camera may include which room in a house the security camera is to be disposed in, information concerning lighting conditions in the room, information concerning other security devices in various rooms in the house, the floor plan of the house, etc. The user or technician may have difficulty gathering and utilizing the location information to optimally configure the security camera to cooperate with other devices in the house.

### SUMMARY OF INVENTION

An embodiment of the present invention relates to a method for configuring at least one of a first device, a second device, and an application system. The application system may be utilized in a spatial unit. The spatial unit may include a plurality of spatial subunits. The method may include determining a first spatial subunit in the spatial unit. The first spatial subunit may be related to the first device. The method may also include identifying, based on a result of the determining, a second device that is physically disposed in the first spatial subunit. The method may also include configuring the at least one of the first device, the second device, and the application system using at least a first rule, wherein the first rule may involve at least the first device and the second device.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a schematic representation an example design of an example prior art automation arrangement.

FIG. 2 shows a schematic representation of a system in accordance with one or more embodiments of the present invention for facilitating automation in an automation system/arrangement that involve multiple devices.

FIG. 3 shows a schematic representation of a relational database in accordance with one or more embodiments of the present invention.

FIG. 4 shows a schematic representation illustrating a collaborative system/arrangement for creating and/or changing standard device templates for automation systems in accordance with one or more embodiments of the present invention.

FIG. 5 shows a flowchart illustrating a rule that specifies relations among one or more events and/or one or more commands in accordance with one or more embodiments of the present invention.

FIG. 6 shows a schematic representation of an automation process involving one or more events and one or more commands in an automation system/arrangement in accordance with one or more embodiments of the present invention.

FIG. 7 shows a flowchart illustrating a setup process for an automation system in accordance with one or more embodiments of the present invention.

FIG. 8 shows a schematic representation illustrating a configuration system for adding devices to an application system, such as an automation system.

FIG. 9 shows a flowchart illustrating a method for adding a device to an application system.

FIG. 10 shows a flowchart illustrating a method for utilizing location information to add and/or configure a device in an application system.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

One or more embodiments of the present invention relate to a system for facilitating automation that involves multiple devices. The devices may include one or more devices that are in compliance with the GPL and one or more devices that are not in compliance with the GPL. For example, the devices may include an Asterisk® phone device and a motion sensor utilizing a Z-Wave interface. With the system according to the invention, the automation may be implemented without the problems of license conflicts and complexity in prior art arrangements.

The system may include a router for forwarding messages among the devices. The system may also include a one or more wrappers implemented in the router and/or in one or more of the devices involved in the automation. As an example, the system may include a first wrapper implemented in a first device among the devices. The first device may be implemented utilizing a first protocol, e.g., the Asterisk® protocol or the Z-Wave protocol. The first wrapper may translate between the first protocol and several types of messages. For example, the first wrapper may translate between the first protocol and a first message that contains configuration data for the first device. The configuration data may include one or more values for one or more operating parameters for the first device. For example, the operating parameters for the Asterisk® phone device may include the number of rings before a call is directed to a voicemail box, the speaker volume of the phone, and microphone volume of the phone, etc.

The first wrapper may also translate between the first protocol and a second message that contains at least a command. The command may instruct the first device and/or one or more other devices to perform one or more actions, such as making a phone call, turning on a light, etc.

The first wrapper may also translate between the first protocol and a third message that contains an event representation. As an example, the event representation may describe one or more events that involve one or more of the devices. As an example, an event may by represented by “Incoming Call,” “Sensor Tripped,” and/or “Media Ended.”

The router and the wrappers may facilitate the control and/or the interworking of the devices. Given the translation performed by the wrappers and the message forwarding performed by the router, the problem of license conflicts as existing in the prior art may be prevented. Further, the router and the wrappers may enable adding new devices in an automation arrangement without requiring adding new interfaces in other devices in the automation arrangement. Advantageously, the problems of complexity and high costs may be avoided.

In one or more embodiments, the present invention may relate to a method for facilitating automation involving multiple devices. The method may include translating between protocols and messages. The messages may contain configuration data, command messages, and/or event representations. The method may also include forwarding/routing the messages for setting up devices, triggering actions, reporting events, etc. The method may also prevent license conflicts and reduce costs in implementing automation arrangements.

One or more embodiments of the invention may relate to an automatic-configuration method for adding a device to an application system, such as an automation system, security system, and/or entertainment system. Utilizing the method, the user of the application system may simply need to couple the device to the application system, and the information needed for the device to operate in the application system may be automatically added to the configuration data database associated with the application system. The device may be efficiently and effectively added without requiring the user to perform any manual software installation or any manual configuration.

The method may include associating a set of Media Access Control (MAC) address ranges with a set of device providers. The method may also include automatically obtain the MAC address associated with the device from a broadcast packet sent by the device. The method may also include automatically determining the provider of the device if the MAC address is within a MAC address range in the set of MAC address ranges. As an example, the method may involve determining the provider of the device based on the first three bytes of the MAC address. The method may also include automatically retrieving additional information concerning the device utilizing the MAC address and/or the device provider information, and then adding the information concerning the device to the configuration data database. In comparison with conventional processes, this automatic-configuration method may be substantially simpler for users and substantially more robust (e.g., against potential errors).

In one or more embodiments, the invention may relate to an automatic-configuration system for implementing the automatic-configuration method.

One or more embodiments of the invention may relate to a configuration method for configuring a device and/or related devices when the device is added to an application system (e.g., an automation system) or is to be reconfigured based on a user request. In contrast with prior art methods, the method may not require a user or technician to have detailed knowledge of the location information, and the method may minimize or eliminate the need for the user or technician's efforts to manually adapt device and application system configuration based on detailed location information. The method may involve utilizing pre-stored, comprehensive physical location information (or spatial information) and rules to optimize the performance of the application system. Advantageously, in accordance with one or more embodiments of the invention, the configuration process for the application system may be substantially simplified, and user experience in utilizing the application system may be optimized.

The method may include pre-storing location information in an environment data database. The location information may relate to the locations or spatial subunits in one or more spatial units, e.g., rooms or cubicles in an office, apartment, house, building, or factory, where various devices of an application system are disposed. At least a substantial portion of the location information may be automatically detected and stored when devices are added or moved. A portion of the location information may be entered by the user at the user's convenience or upon the changes to the devices.

The method may also include determining the identifier of at least one spatial subunit that is related to device. For example, a television may be disposed in the living room (a spatial subunit) in a house (a spatial unit); the identifier of the living room (e.g., “Room 1”) may be identified. As another example, a security panel may be related to the storage room (a first spatial subunit) where a motion sensor coupled with the security panel is disposed but may be disposed in the manager's office (a second spatial subunit) in an office building (a spatial unit); the identifiers of the manager's office and the storage room may be identified.

The method may also include automatically identifying, e.g., utilizing the identifier of the spatial subunit and the location information stored in the environment data database, other devices that are physically disposed in the spatial subunit. For example, a second device, e.g., a lamp, disposed in the living room may be identified. As another example, a motion sensor disposed in the storage room may be identified. In one or more embodiments, the method may also include identifying the locations of the devices that may be related to the new/reconfigured device based on the location information and other correlation data.

The method may also include automatically configuring the new/reconfigured device, one or more of the devices disposed in the spatial subunit, and/or one or more other devices in the application system using at least a location-related rule contained in a configuration script, which may be pre-written and pre-stored in a configuration script database. For example, the rule may require that the lamp to be dimmed when the television in the same room is turn on. As another example, the rule may require the security panel in the manager's office to send a text message to the user if the motion sensor in the storage room is tripped.

As can be readily appreciated from the above discussion, the method may efficiently and effectively utilize location information to optimize the performance or the application system.

In one or more embodiment, the invention may relate to a configuration system for implementing the configuration method that involves location information.

The features and advantages of the invention may be better understood with reference to the figures and discussions that follow.

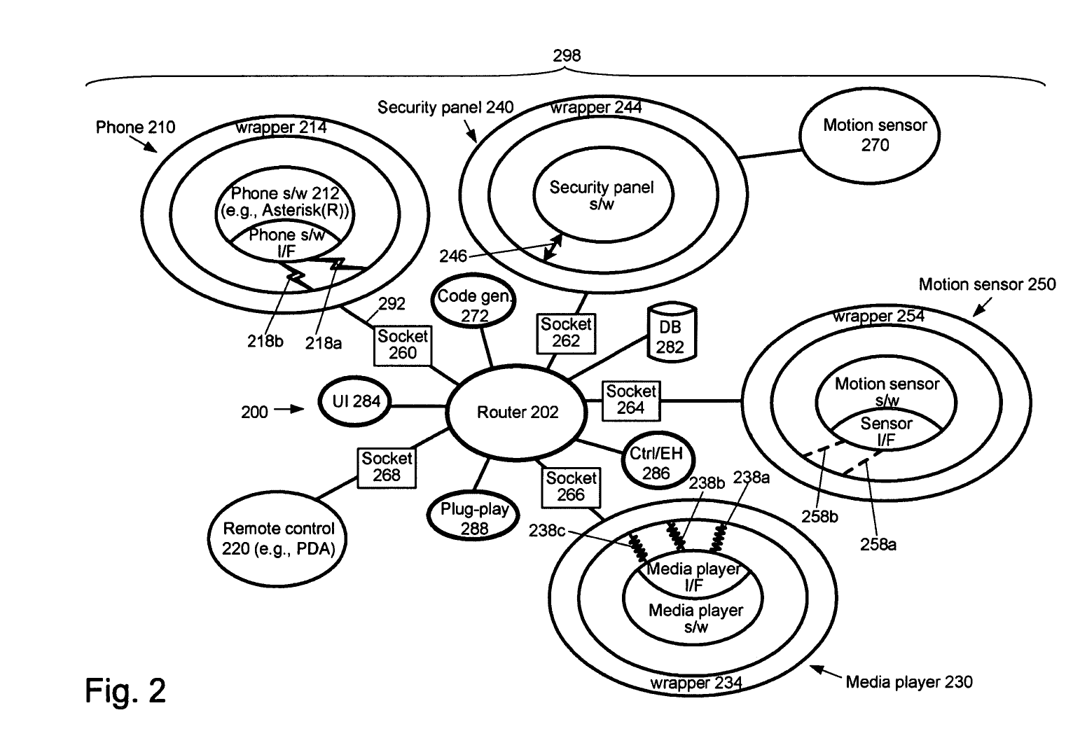

FIG. 2 shows a schematic representation of a system 200 in accordance with one or more embodiments of the present invention for facilitating automation in an automation system/arrangement 298 (hereinafter “arrangement 298”) that involve multiple devices. As an example, arrangement 298 may involve a phone 210 (such as an Asterisk® phone), a security panel 240, motion sensors 250 and 270, a media player 230 (such as a xine media player), and a remote control device 220 (such as a personal digital assistant, hereinafter “remote control 220”).

System 200 may include one or more of the following components: wrappers (such as wrappers 214, 244, 254, and 234), a router 202, a user interface element 284, a relational database 282, a control element 286 (or event handler 282), a plug-and-play module 288, and a code generator 272. The wrappers may translate between protocols and messages. The messages may include configuration data messages, command messages, and/or event representation messages. The messages may be called data/command/event messages, or DCE messages. Router 202 may be coupled with the devices through sockets, such as sockets 260, 262, 264, 266, and 268; router 202 may forward the messages among the devices through the sockets. User interface element 284 may provide a consistent, unified environment for a user to provide input, for example, related to configuration and/or control logic. Relational database 282 may store and correlate various data for facilitating the automation of the devices. Control element 286 may intercept event information in arrangement 298 and may control the forwarding of messages, for example, based on standard/default control logic and/or user-specified control logic. Plug-and-play module 288 may detect devices to be included in arrangement 298. Code generator 272 may automatically generate code for the wrappers based at least in part on templates stored in relational database 282. The components of system 200 are further discussed below utilizing phone 210 as an example.

For including phone 210 in arrangement 298, wrapper 214 may be implemented in phone 210 and/or router 202 to translate between phone system protocol messages (e.g., Asterisk® protocol messages 218a and 218b) and DCE messages (e.g., a DCE message 292). For example, configuration data, which include values for operating parameters for phone 210, may be received through user interface element 284 and may be sent to phone 210 in a configuration-data message. Wrapper 214 may translate the configuration-data message to obtain the values for the operating parameters according to the Asterisk® protocol. The values for the operating parameters may then be utilized by phone 210 for configuring Asterisk® software 212 (and/or relevant firmware in phone 210). As another example, command and event information generated by Asterisk® software 212 (and/or the firmware) may be translated by wrapper 214 into one or more command and/or event messages. The command and/or event messages may be forwarded by router 202 to one or more of the other devices for triggering/instructing actions, reporting status/events, etc.

Similarly, for example, wrapper 254 may translate between proprietary-wireless-protocol messages (e.g., Z-Wave messages 258a and 258b) and DCE messages; wrapper 234 may translate between media player protocol messages (e.g., xine messages 238a, 238b, and 238c) and DCE messages; etc.

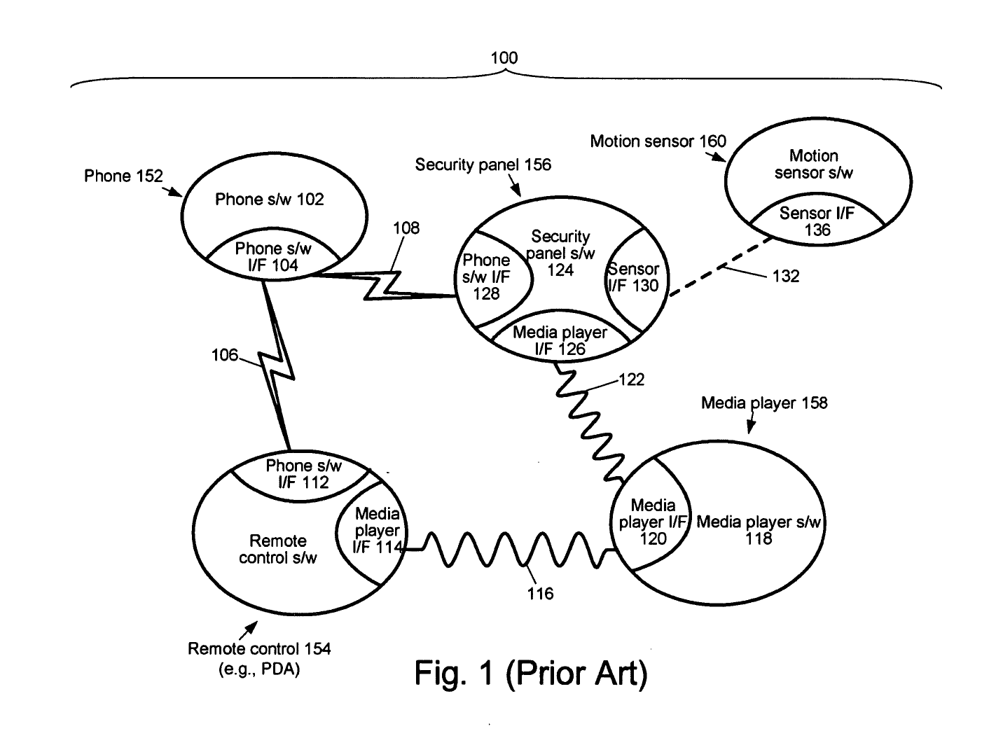

As can be appreciated from the example of FIG. 2, utilizing DCE messages, security panel 240 may communicate with phone 210 through a standard serial interface 246, wrapper 244, socket 262, router 202, socket 260, and wrapper 214 for various automation purposes. No additional interfaces (as interfaces 126, 128, and 130 required in the prior art arrangement 100 shown in the example of FIG. 1) need to be implemented in security panel 240 or any other devices in arrangement 298. According, there are no license conflicts in arrangement 298. Further, the implementation, management, and maintenance costs for arrangement 298 may be minimized.

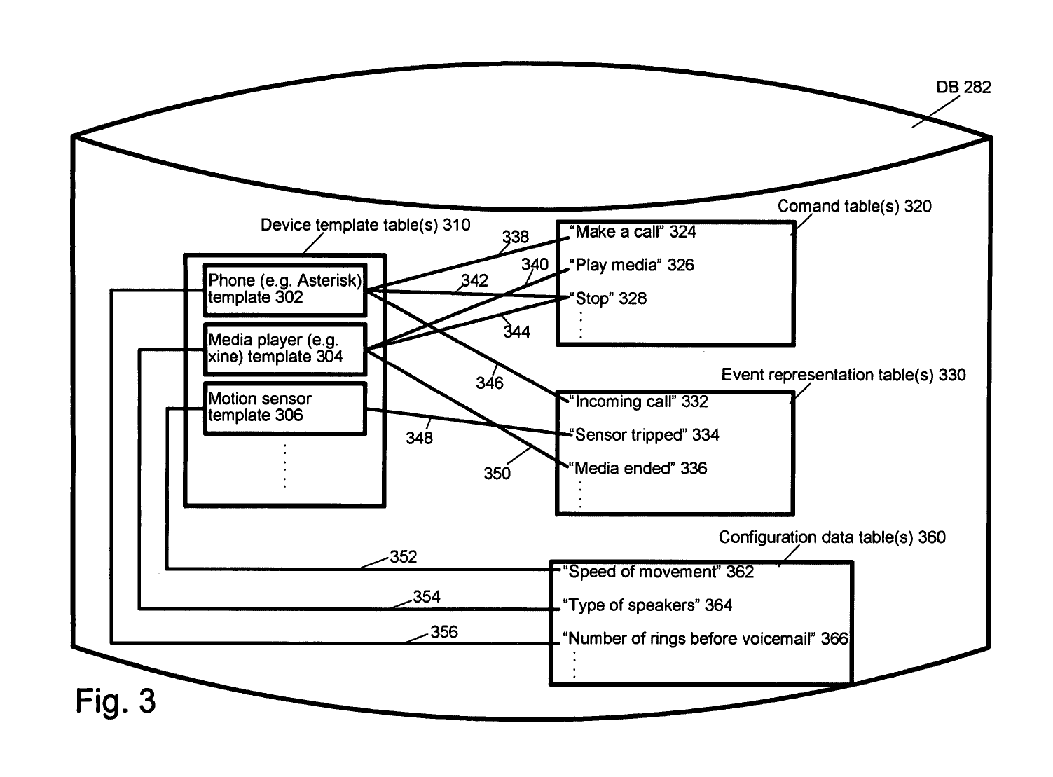

FIG. 3 shows a schematic representation of relational database 282 (also illustrated in the example of FIG. 2) in accordance with one or more embodiments of the present invention. Relational database 282 may include a device template table set 310, a command table set 320, an event representation table set 330, and a configuration data table set 360. Each of the table sets may include one or more data tables.

Device template table set 310 may include various device templates for various devices in arrangement 298 (illustrated in the example of FIG. 2). For example, device template table set 310 may include a phone template 302 (e.g., an Asterisk® template) for phone 210 (illustrated in the example of FIG. 2), a media player template 304 (e.g., a xine template) for media player 230 (illustrated in the example of FIG. 2), and a motion sensor template 306 for motion sensor 250 (illustrated in the example of FIG. 2). Relational database 282 may relate the device templates to various parameters (or data fields) and/or data values in command table set 320, event representation table set 330, and configuration data table set 360.

The device templates may be utilized by code generator 272 (illustrated in the example of FIG. 2) to automatically generate wrappers for one or more of the devices in arrangement 298. For example, phone template 302 may be utilized by code generator 272 for generating wrapper 214 (illustrated in the example of FIG. 2); media player template 304 may be utilized for generating wrapper 234 (illustrated in the example of FIG. 2); motion sensor template 306 may be utilized for generating wrapper 254 (illustrated in the example of FIG. 2).

The device templates may also be utilized by user interface element 284 (illustrated in the example of FIG. 2) to present appropriate configuration options to a user for receiving relevant user input. The user input may be utilized for customizing operating parameters of the devices and/or for customizing rules governing relations (e.g., logical relations, timing relations, etc.) among commands/events pertaining to the devices. For example, user interface element 284 may enable the user to choose the speaker volume when the user is configuring phone 210 and may enable the user to choose the sensitivity level when the user is configuring motion sensor 270. As another example, user interface element 284 may enable the user to relate the “Media is being Played” event with “Turn off the Light” command. Advantageously, a single, unified user interface may be provided for the user to configure various devices; the user may not need to learn different user interfaces for configuring different devices.

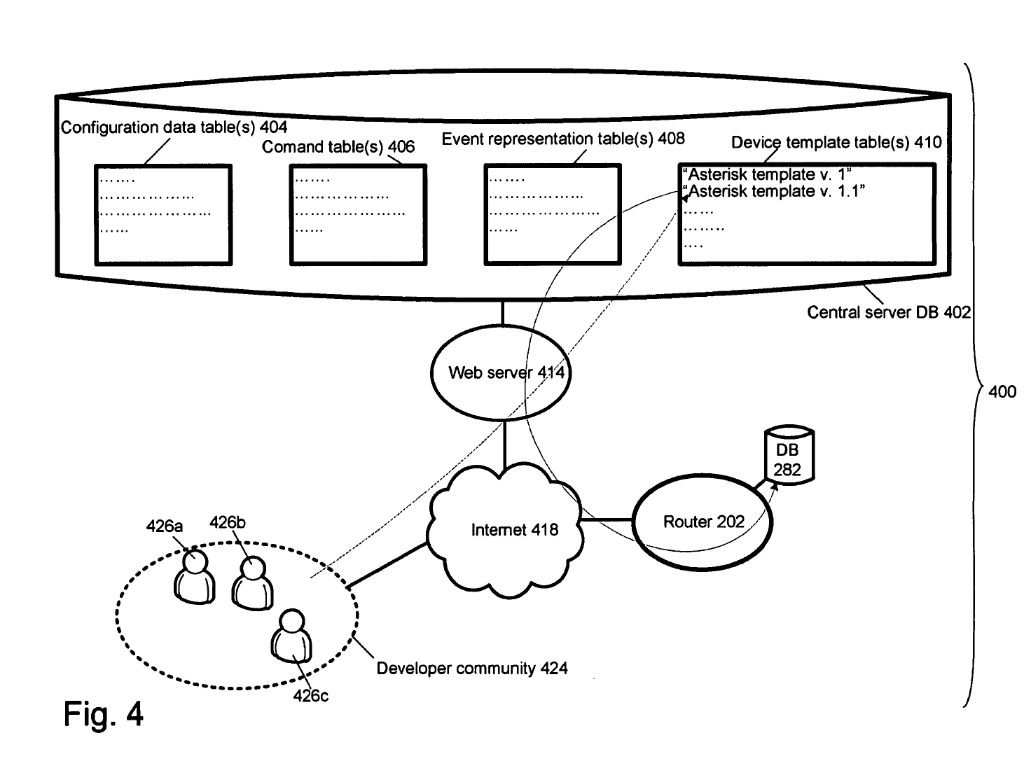

The device templates may also store configuration data. The configuration data may include standard configuration data provided by a central server database (to be further discussed in the example of FIG. 4) and customized configuration data specified by a user. The configuration data may be provided to individual devices in configuration-data messages, which may be translated by wrappers to obtain values for operating parameters according to appropriate protocols. Accordingly, the configuration data for various devices are stored in one database separate from the devices. Advantageously, the user may utilize the stored configuration data of a device (e.g., a malfunctioning device) to conveniently configure a new, replacement device the need of going through many steps to reconfigure the new device.

Command table set 320 may contain commands that may be utilized for instructing one or more devices in arrangement 298 to perform one or more actions. Relational database 282 may correlate the commands with templates in device template table set 310. For example, command table set 320 may include a command “Make a Call” 324 related to a phone template 302 through link 338. Command table set 320 may also include a command “Play Media” 326 related to a media player template 304 through a link 340. Command table set 320 may also include a command “Stop” 328 related to phone template 302 through a link 342 and related to media player template 304 through a link 344. As an example, a user may send out command “Stop” 328 by pressing a stop button on remote control 220 (illustrated in the example of FIG. 2) when phone 210 and media player 230 are active. According to phone template 302, wrapper 214 may interpret command “Stop” 328 as “Hang up the Call.” On the other hand, according to media player template 304, wrapper 234 may interpret command “Stop” 328 as “Stop Playing the Media.” Advantageously, the same signal received from the same control device may be utilized for instructing different devices to perform different actions. In one or more embodiments, motion sensor template 306 may not be related to any commands in command table set 320.

Event representation table set 330 may include descriptions/representations of various events pertaining to the devices in arrangement 298. For example, the event representations may include a representation “Incoming Call” 332 related to phone template 302 through a link 346, a representation “Sensor Tripped” 334 related to motion sensor template 306 through a link 348, and a representation “Media Ended” 336 related to media player template 304 through link 350.

Configuration data table set 360 may contain various parameters (or data fields) and/or data values pertaining to the configurations of one or more devices in arrangement 298. For example, configuration data table set 360 may include a parameter “Speed of Movement” 362 related to motion sensor template 306 through a link 352, a parameter “Type of Speakers” 364 related to media player template 304 through a link 354, and a parameter “Number of Rings before Voicemail” 366 related to phone template 302 through a link 356.

FIG. 4 shows a schematic representation illustrating a collaborative system/arrangement 400 (arrangement 400) for creating and/or changing standard device templates in accordance with one or more embodiments of the present invention. Arrangement 400 may include a central server database 402 for storing standard/default device templates, standard/default data, and standard/default rules. Central server database 402 may contain several data table sets: a configuration data table set 404 for storing standard/default configuration data (or operating parameter values) for various devices; a command table set 406 for storing standard/default commands for instructing actions to be performed by the devices; an event representation table set 408 for storing standard/default representations for events involving the devices; a device template table set 410 for storing device templates that contain standard/default data fields, data values, and/or rules. The rules may govern various relations among configuration data, commands, and events.

Central server database 402 may also be coupled with relational database 282 through router 202 and internet 418. Accordingly, depending on the devices in arrangement 298 (illustrated in the example of FIG. 2), relational database 282 may download applicable standard/default device templates, standard/default data, and standard/default rules from central server database 402.

Arrangement 400 may also include a web server 414. Central server database 402 may be coupled with a developer community 424 through web server 414 and the internet 418. Web server 414 may provide a user interface for creating and/or changing data fields and/or data values stored in central server database 402. Web server 414 may also facilitate creation and updates of device templates. Through internet 418 and web server 414, developers (such as developers 426a, 426b, and 426c) in developer community 424 may create new device templates. The developers may also change existing device templates by changing associated data fields, data values, and/or rules.

The creation and changes may be performed in a collaborative fashion, though the developers in developer community 424 may include employees of different organizations and/or enterprises. As an example, device template table set 410 may initially contain a standard Asterisk® template version 1 provided by Digium, Inc. Through internet 418, the standard Asterisk® template version 1 may be automatically downloaded to relational database 282. Through the user interface provided by web server 414, one or more developers in developer community 424 that are not Digium, Inc. employees may create a revised standard Asterisk® template version 1.1, for example, by adding more commands to Asterisk® template version 1. After the new standard Asterisk® template version 1.1 has been created, Asterisk® template version 1.1 may be pushed or pulled to relational database 482.

As can be appreciated from the example of FIG. 4, embodiments of the invention may leverage vast developer resource to enhance device templates. Advantageously, the performance and functionality of arrangement 298 may be effectively improved.

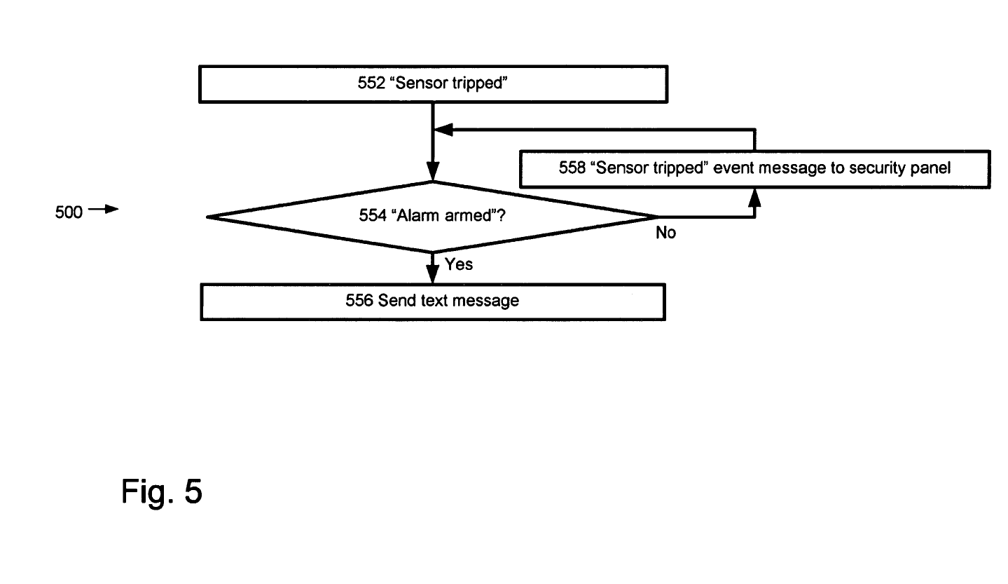

FIG. 5 shows a flowchart illustrating a rule 500 that specifies relations among one or more events and/or one or more commands in accordance with one or more embodiments of the present invention. As discussed in the example of FIG. 2, control element 286 (or an event handler) may intercept information concerning events involving the devices in arrangement 298. Based on the event information and predefined rules (e.g., logical relations), control element 286 may direct router 202 (shown in the example of FIG. 2) to forward messages to appropriate devices for triggering suitable commands and/or events. In the example rule 500 illustrated in FIG. 5, in step 552, control element 286 may monitor arrangement 298 and may receive information pertaining to an event “Sensor Tripped.” In step 554, control element 286 may determine whether there is an event “Alarm Armed” in arrangement 298. If the event “Alarm Armed” does not exist in arrangement 298, in step 558, control element 286 may trigger a “Sensor Tripped” event message to be sent to the security panel for arming the alarm. If the event “Alarm Armed” exists, in step 556, control element 286 may trigger a text message to be sent to the user of arrangement 298 for notifying the user of the relevant events, e.g., “Sensor Tripped” and “Sensor Tripped.”

Rule 500 may be easily defined by the user by linking data elements in relational database 282 without requiring the user or a technician to write code. Alternatively or additionally, rule 500 may be included in one or more standard device templates and/or other data downloaded to relational database 282 from central server database 402 (shown in the example of FIG. 4).

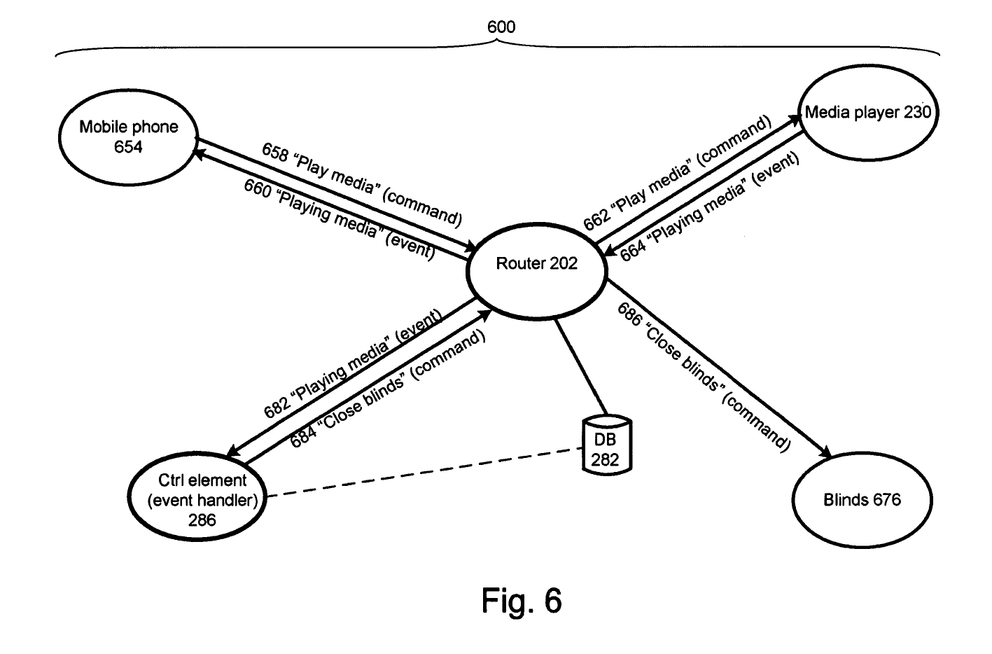

FIG. 6 shows a schematic representation of an automation process involving one or more events and one or more commands in an automation system/arrangement 600 (hereinafter “arrangement 600”) in accordance with one or more embodiments of the present invention. Arrangement may include router 202, control element 286, relational database 282, and wrappers similar to those discussed in the example of FIG. 2.

In step 658, mobile phone 654 may send a message containing a command “Play Media” to router 202.

In step 662, router 202 may forward the message containing the command “Play Media” to media player 230. Subsequently, wrapper 234 in media player 230 may translate the message to obtain the command “Play Media” according to the protocol utilized by media player 230. Accordingly, media player 230 may proceed with playing the requested media (e.g., an audio/video file).

In step 664, media player 230 may send a message containing a representation of the event “Playing Media” to router 202.

In step 660, router 202 may forward the message containing the event representation of “Playing Media” to mobile phone 654. Accordingly, mobile phone 654 may generate an indication and/or confirmation message through the user interface of mobile phone 654 for notifying the user of the event “Playing Media.”

In step 682, router 202 may also send a copy of the message containing the event representation of “Playing Media” to control element 286. Control element 286 may check one or more rules that are stored in relational database 282 and related to the event “Playing Media.”

In step 684, based on the event “Playing Media” and the related rule(s), control element 286 may send a message containing a command “Close Blinds” to router 202.

In step 686, router 202 may forward the message containing the command “Close Blinds” to blinds 676. Accordingly, blinds 676 may close.

In arrangement 600, the automation process is completed utilizing message translation and forwarding. No extra interfaces need to be implemented in the devices.

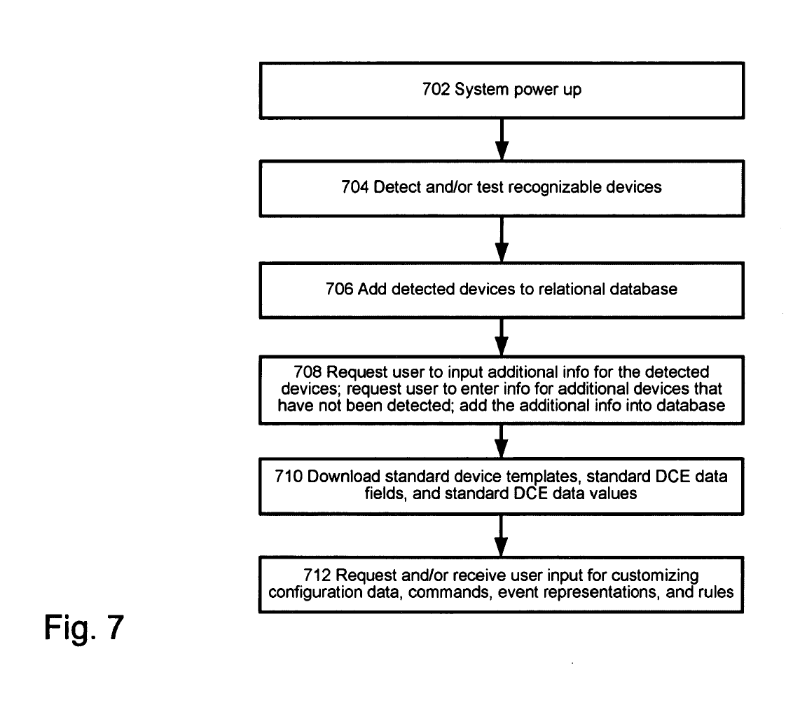

FIG. 7 shows a flowchart illustrating a setup process for system 200 and arrangement 298 (shown in the example of FIG. 2) in accordance with one or more embodiments of the present invention. The process may start with 702, in which the power of system 200 is up, i.e., system 200 is turned on.

In step 704, system 200 (or one or more plug-and-play modules, e.g., plug-and-play module 288) may detect and/or test recognizable devices through various connections. Plug-and-play module 288 may be configured to detect devices directly and indirectly connected to system 200. For example, plug-and-play module 288 may detect motion sensor 270, which is indirectly connected to router 202 through security panel 240.

In step 706, system 200 may add the detected devices to relational database 282.

In step 708, system 200 may request the user to enter information pertaining to additional devices that have not been detected. System 200 may also request the user to input additional information for the detected devices. For example, the additional device information may include the location of certain devices, for example, e.g., in which room a television is located. System 200 may also add the additional devices and additional device information to database 282.

In step 710, system 200 may download standard device templates from central server database 402 (shown in the example of FIG. 4). System 200 may also download standard data fields and data values for configuration data, commands, and/or event representations from central server database 402.

In step 712, system 200 may request and/or receive user input for customizing configuration data, commands, event representations, and rules for operating arrangement 298 (shown in the example of FIG. 2).

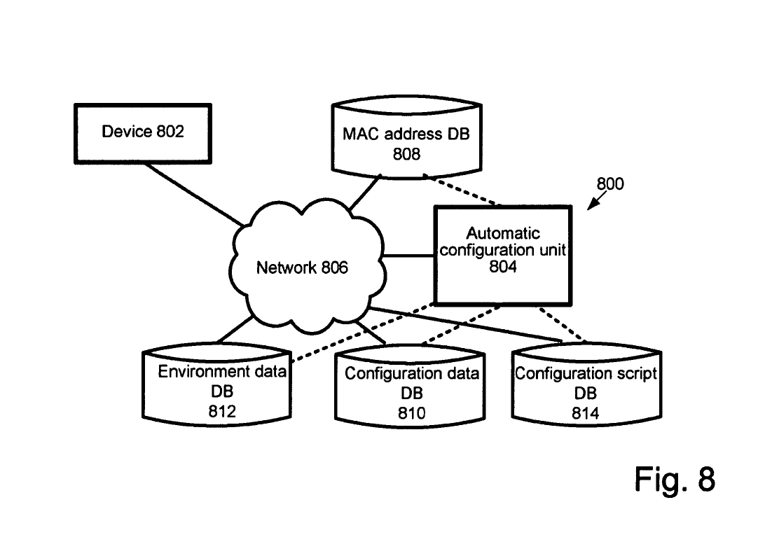

FIG. 8 shows a schematic representation illustrating an automatic-configuration system 800 for adding devices to an application system, such as an automation system, e.g., arrangement 298 illustrated in the example of FIG. 2. For example, the application system may include a group of devices, such as communication devices, entertainment devices, security devices, etc., coupled through a network 806, such as a home network. Automatic-configuration system 800 may automatically add a new device, for example, device 802, to the application system once the device has been coupled to network 806, e.g., through a wireless connection or a wireline connection. In contrast with prior art systems and methods, automatic-configuration system 800 may require minimum or no manual software installation and configuration to be performed by a user or system administrator.

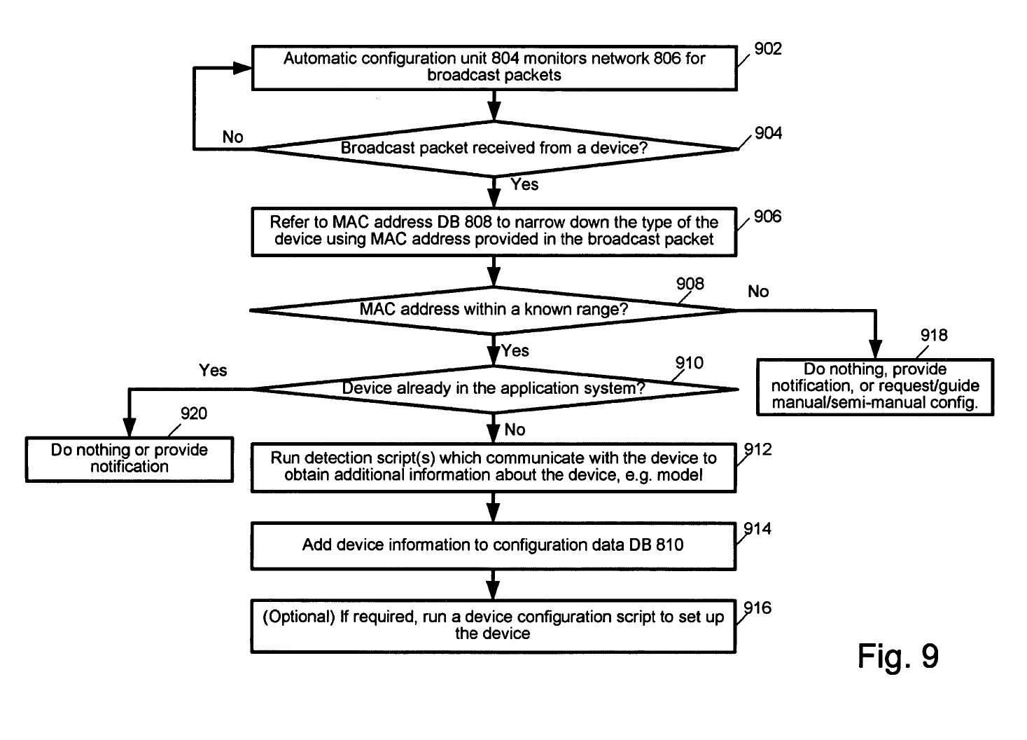

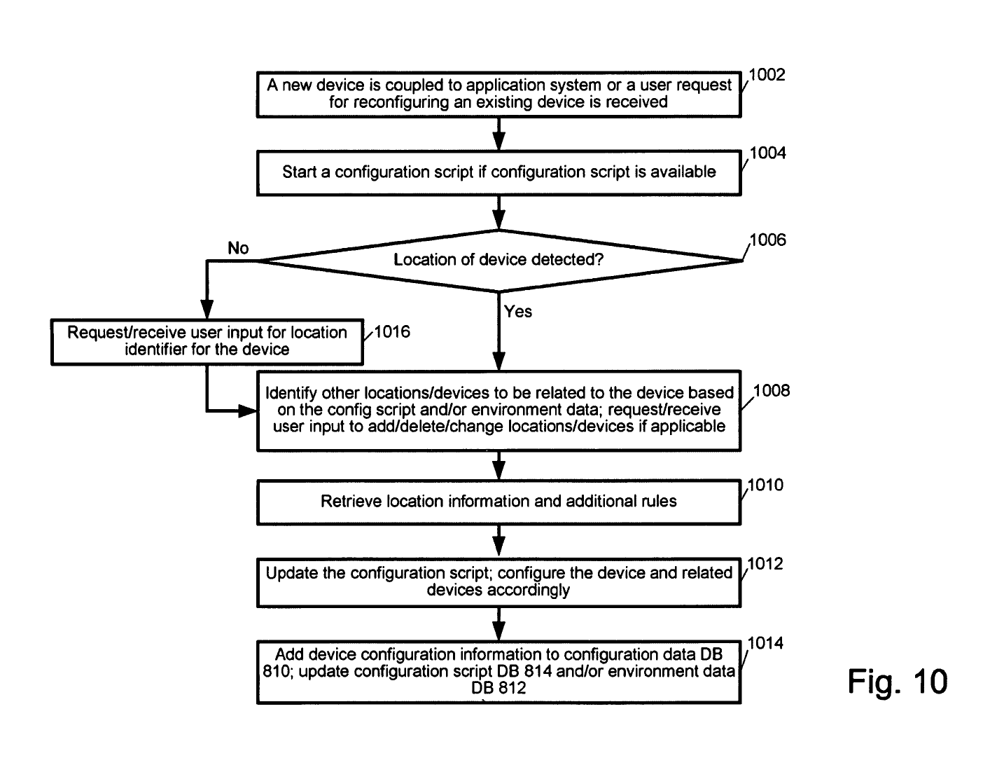

Automatic-configuration system 800 may include an automatic-configuration unit 804, a Media Access Control (MAC) address database 808, a configuration script database 814, and/or an environment data database 812 for obtaining and/or generating appropriate information for devices that are newly coupled to network 860. The information may be automatically added to a configuration data database 810 associated with the application system such that the newly coupled devices may be successfully included to operate in the application system. Example functions, features, and advantages of automatic-configuration system 800 are further discussed with reference to the examples of FIG. 9 and FIG. 10.

FIG. 9 shows a flowchart illustrating a method for adding a device to an application system. The method may be implemented, for example, utilizing automatic-configuration system 800 illustrated in the example of FIG. 8. The method may start with step 902, in which automatic-configuration unit 804 may operate in a promiscuous mode (or sniffing mode), monitoring network 806 for broadcast packets.

In step 904, automatic-configuration unit 804 may determine whether any broadcast packets are received from any devices. A device may send a broadcast packet, such as a DHCP (Dynamic Host Configuration Protocol) request, for requesting an Internet Protocol (IP) address after being coupled to network 806. The broadcast packet may contain the MAC address associated with the device. Accordingly, if automatic-configuration unit 804 receives a broadcast packet, automatic-configuration unit 804 may be able to determine the MAC address associated with the device that is newly coupled to network 806. In one or more embodiments, automatic-configuration device 804 may represent a DHCP server, which may determine that an IP address has been assigned to a device.

If no broadcast packets are received by automatic-configuration unit 804, control may be transferred back to step 902. If a broadcast packet is received from a device, for example, device 802, control may be transferred to step 906.

In step 906, automatic-configuration unit 804 may refer to MAC address database 808 to narrow down the type of device 802 based on the MAC address provided in the broadcast packet and associated with device 802.

For example, MAC address database 808 may contain information associating various MAC address ranges with various device manufacturers/providers. Accordingly, if the MAC address is within a particular MAC address range stored in MAC address database 808, then the manufacturer/provider of device 802 may be determined based on the association information. For example, automatic-configuration system 800 may determine the manufacturer/provider of device 802 based on the MAC address associated with device 802.

In general, the first three bytes (or digits) of a MAC address is an Organization Unique Identifier (OUI) that may be associated with a particular manufacturer/provider. In one or more embodiments, the information concerning the association between MAC addresses (or MAC address ranges) and device manufactures/providers may be obtained by performing an Internet/Web search.

Additional MAC address numbering schemes (e.g., for the fourth to sixth bytes of MAC addresses) of various manufactures may also be determined. For example, a manufacture may have different MAC address numbering schemes for different product lines. MAC address database 808 may also store information associating additional MAC address numbering scheme information and additional device information for further narrowing down the device type.

In one or more embodiments, MAC address database 808 may be part of a central server database, such as central server database 402 illustrated in the example of FIG. 4, managed by a service provider. Automatic-configuration unit 804 may be coupled with the central server database through the Internet. In one or more embodiments, MAC address database 808 may be a local database coupled with automatic-configuration unit 804 directly or through network 806.

In step 908, automatic-configuration unit 804 may determine whether the MAC address associated with device 802 is within a known MAC address range stored in MAC address database 808. If the MAC address is not within a known MAC address range, control may be transferred to step 918. If the MAC address is within a known MAC address range, control may be transferred to step 910.

In step 918, automatic-configuration unit 804 may do nothing, may provide a notification to inform the user that the type of device 802 is unknown, or, as a fall-back mechanism, may request and/or guide the user to manually or semi-manually add device 802 to the application system.

In step 910, automatic-configuration unit 804 may refer to configuration data database 810 to determine, e.g., based on the MAC address, whether device 802 is already in the application system, i.e., whether device 802 has been previously added to the application system with relevant configuration data stored configuration data database 810. If device 802 is already in the application system, control may be transferred to step 920. If device 802 is not yet in the application system, control may be transferred to step 912.

In step 920, automatic-configuration unit 804 may do nothing or may provide a notification to inform the user that device 802 is already in the application system.

In step 912, automatic-configuration unit 804 may run one or more detection scripts which may communicate with device 802 and/or other information sources to obtain additional information about the device, e.g. the model of device 802, the protocols utilized by device 802, one or more other specifications of device 802, etc.

For example, a detection script may ping device 802. As another example, a detection script may utilize retrieving software (e.g., Wget available from www.gnu.org) to retrieve relevant information from one or more Web servers. The MAC address and/or the device provider information obtained in step 906 may be utilized for retrieving the additional information.

In step 914, automatic-configuration unit 804 may add the information concerning device 802 (obtained from steps 906 and 912) to configuration data database 810. If no further device-level configuration is required, device 802 may have been successfully added and may properly operate in the application system. If further device-level configuration is required, control may be transferred to step 916.

In step 916, automatic-configuration unit 804 run a pre-written, pre-stored device configuration script (retrieved from configuration script database 814) to set up device 802. Accordingly, the application system may be successfully configured to include device 802.

In one or more embodiments, configuration script database 814 may be part of a central server database, such as central server database 402 illustrated in the example of FIG. 4, managed by a service provider, and may be coupled with automatic-configuration unit 804 through the Internet. In one or more embodiments, configuration script database 814 may be a local database coupled with automatic-configuration unit 804 directly or through network 806.

As can be appreciated from the example of FIG. 9, in accordance with one or more embodiments of the invention, minimum or no user involvement may be required for adding most devices (e.g., from well-known manufacturers) to application systems. The process may be substantially simpler for users and substantially more robust than conventional processes.

In one or more embodiments, one or more features of automatic-configuration system 800 and/or illustrated in the example of FIG. 9 may be combined with one or more features with reference to one or more of the examples of FIGS. 2-7.

FIG. 10 shows a flowchart illustrating a method for utilizing location information to add and/or configure a device in an application system, such as an automation system, security system, and/or entertainment system. The method may be implemented, for example, utilizing automatic-configuration system 800 illustrated in the example of FIG. 8. The method may start with step 1002, in which a new device, e.g., device 802 representing a new device, may be coupled to the application system. Alternatively or additionally, configuration system 800 may receive a user request for reconfiguring an existing (or previously coupled) device, e.g., device 802 representing an existing device, in the application system.

In step 1004, if device 802 represents a newly coupled device and if device 802 is unknown to automatic-configuration system 800 (e.g., no configuration data concerning device 802 are stored in configuration data database 810 and/or no configuration scripts for device 802 are available in configuration script database 814), automatic-configuration system 800 (or automatic-configuration unit 804) may provide a notification to inform the user that device 802 is unknown; automatic-configuration unit 804 may also request and/or guide the user to perform manual configuration. If device 802 is a known device (e.g., a configuration script for device 802 exists in configuration script database 814), automatic-configuration system 800 (or automatic-configuration unit 804) may start the configuration script to configure standard settings for device 802 and to gather further information.

In step 1006, automatic-configuration system 800 (or automatic-configuration unit 804) may determine whether the location of device 802 is detected. The location of device 802 may be represented by a location identifier, e.g., a spatial subunit identifier, a room name, or a room number. For example, in a house (i.e., a spatial unit), the living room where a television is disposed may be represented the spatial subunit identifier “Room 1” or “Living Room.” As another example, in an office building, the manager's office where a security panel is disposed may be represented by the spatial subunit identifier “Location M1.”

The location of device 802 may be detected utilizing one or more detection arrangements, for example, utilizing a connection port or a wireless detection mechanism (e.g., based on the Bluetooth® sensing technology available from www.bluetooth.com or an infrared sensing technology). If the location of device 802 is not detected, control may be transferred to step 1016, in which automatic-configuration system 800 (or automatic-configuration unit 804) may request the user to provide the location information for device 802, for example, by selecting a spatial subunit identifier. If the location of device 802 is detected, control may be transferred to step 1008.

In step 1008, automatic-configuration system 800 (or automatic-configuration unit 804) may identify other locations and/or other devices to be related to device 802 based on the configuration script and/or environment information.

The configuration script may include one or more rules defining relations between device 802 (i.e., a device of the type of device 802 and disposed in the location of device 802) and other devices in the application system. For example, a rule may require that if a television in a room is turned on, a first lamp in the same room should automatically dim, and a second lamp in the same room should automatically turn on. As another example, a rule may require that if an infrared sensor in Room A1 in Building A is tripped, a lamp la008 in Room A1 in Building A should automatically turn on, a camera ca025 in Room A1 in Building A should automatically start recording, a camera ca012 in Room B3 in building B should start recording, a door do055 in Room C2 in building C should be automatically locked.

The environment information may be retrieved from environment data database 812 and/or configuration data database 810; the environment information may include data pertaining to physical locations of devices that are related to device 802. For example, the environment information may include data concerning the devices disposed in Room A1, Room B3, Room C2, etc. Alternatively or additionally, the environment information may include the locations of cameras, lamps, etc. The environment information may enable the implementation and execution of the rules.

In step 1008, automatic-configuration system 800 (or automatic-configuration unit 804) may allow the user to add, delete, and/or change locations of the devices related to device 802. Alternatively or additionally, automatic-configuration unit 804 may allow the user to add, delete, and/or change devices that are to be related to device 802. For example, the user may relate an additional door lock dl088 in Room B3 to the infrared sensor; the user may remove the relations between devices in Room A1 and devices in Room C2; the user may change the location of the lamp la008 from Room A1 in Building A to Room D2 in building D. In one ore more embodiments, automatic-configuration system 800 may update environment data database 812 when locations of devices are changed, and the user may not need to manually change locations of devices.

In step 1010, automatic-configuration system 800 (or automatic-configuration unit 804) may retrieve additional environment information and additional rules (e.g., from other configuration scripts stored in configuration script database 814) in response to the changes made in step 1008.

In step 1012, automatic-configuration system 800 (or automatic-configuration unit 804) may update the configuration script concerning device 802 and/or may generate one or more additional configuration scripts. Automatic-configuration system 800 may also configure device 802 and related devices according to the updated configuration script and/or the additional configuration script(s).

In step 1014, automatic-configuration system 800 (or automatic-configuration unit 804) may add the resulted device configuration information concerning device 802 and related devices to configuration data database 810. Automatic-configuration system 800 (or automatic-configuration unit 804) may also update configuration script database 814 and/or environment data database 812.

As can be appreciated form the example for FIG. 10, the configuration method may involve utilizing pre-stored, comprehensive location information and rules to optimize the performance of the application system. Advantageously, user experience in utilizing the application system may be optimized. The method may not require a user or technician to have detailed knowledge of the location information. The method may also minimize the user or technician's efforts to manually adapt device and application system configuration based on detailed location information. Advantageously, the configuration process for the new/reconfigured device and the application system may be simplified.

In one or more embodiments, one or more features of automatic-configuration system 800 and/or illustrated in the example of FIG. 10 may be combined with one or more features with reference to one or more of the examples of FIGS. 2-7 and 9. For example, the introduction of a new device may represent an event that may trigger control element 286 (illustrated in the example of FIG. 2) to provide a command to instruct plug-and-play module 288 (illustrated in the example of FIG. 2) and/or the new device to performs one or more configuration actions.

As can be appreciated from the foregoing, embodiments of the invention may prevent problems of license conflicts and complexity in implementing and operating automation systems/arrangements. Advantageously, implementation, management, and maintenance costs may be minimized. Further, more devices and more systems based on various protocols may be utilized in automation. As a result, the functionality and flexibility of automation systems/arrangements may be substantially enhanced.

Embodiments of the invention may also provide a unified user interface for configuring various devices and for customizing automation rules. Embodiments do not require users or installation technician to perform coding. Advantageously, embodiments of the invention enable easy and efficient configuration and customization.

Embodiments of the invention may also leverage vast, collaborative developer resource to enhance device templates. Advantageously, the performance and functionality of automation systems/arrangements may be may be improved in an efficient and effective fashion.

Embodiments of the invention may also enable automatic configuration for adding devices to application systems, thereby minimizing or eliminating manual operation to be performed by a user or system administrator. Advantageously, the process for adding devices according to the embodiments of the invention may be substantially simpler for users and more robust than conventional processes.

Embodiments of the invention may also store comprehensive location information (or spatial information) and rules pertaining to physical locations of devices in an application system. Accordingly, embodiments may utilize the location information and rules to automatically optimize the interworking of the devices. Advantageously, minimum or no manual adaptation may need to be performed by a user or technician, and user experience in utilizing the application system may be optimized.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A method for configuring at least one of a first device, a second device, and an application system, the application system utilized in a spatial unit, the spatial unit including at least a plurality of spatial subunits, the method comprising:
determining a first spatial subunit in the spatial unit, the first spatial subunit related to the first device;
identifying, based on a result of the determining, a second device that is physically disposed in the first spatial subunit; and
configuring the at least one of the first device, the second device, and the application system using at least a first rule, the first rule involving at least the first device and the second device.

2. The method of claim 1 wherein the first device is physically disposed in the first spatial subunit.

3. The method of claim 1 wherein the first device is not physically disposed in the first spatial subunit.

4. The method of claim 1 wherein the first device is related to the first spatial subunit according to a user command.

5. The method of claim 1 wherein the result of the determining includes at least an identifier of the first spatial subunit.

6. The method of claim 1 further comprising retrieving information concerning at least a third device based at least in part on the result of the determining, the third device physically disposed in the first spatial subunit.

7. The method of claim 1 further comprising retrieving, based at least in part on the result of the determining, information concerning all devices that are physically disposed in the first spatial subunit.

8. The method of claim 1 wherein
the spatial unit includes at least one of a first building, a second building, a unit in the first building, and a unit in the second building, and
the first spatial subunit represents at least one of a room and a cubicle.

9. The method of claim 1 wherein the determining including at least one of detecting the first device and querying a user.

10. The method of claim 1 further comprising:
starting a configuration script for setting up at least the first device; and
updating the configuration script using at least the result of the determining.

11. The method of claim 1 further comprising:
determining a second spatial subunit in the spatial unit based on at least one of the first rule and a second rule; and
configuring one or more of a third device, the first device, the second device, and the application system using at least one of the first rule, the second rule, and a third rule,
wherein the third device physically disposed in the second spatial subunit.

12. The method of claim 11 further comprising:
determining a third spatial subunit in the spatial unit based on at least one of the first rule, the second rule, and a fourth rule; and
configuring one or more of a fourth device, the third device, the first device, the second device, and the application system using at least one of the fourth rule and a fifth rule,
wherein the fourth device is physically disposed in the third spatial subunit.

13. The method of claim 1 further comprising:
receiving user input concerning one or more additional spatial subunits in the spatial units that are to be affected by the first device;
retrieving one or more additional rules concerning the at least one of the first device, the second device, and one or more other devices physically disposed in the one or more additional spatial subunits; and
configuring one or more of the first device, the second device, the one or more other devices, and the application system using at least the one or more additional rules.

14. The method of claim 13 further comprising:
starting a configuration script for setting up at least the first device; and
updating the configuration script using at least the user input.

15. The method of claim 1 further comprising:
receiving user input concerning a second spatial subunit in the spatial unit; and
configuring one or more of a third device, the first device, the second device, and the application system using at least one of the first rule and a second rule,
wherein the third device is physically disposed in the second spatial subunit.

16. The method of claim 15 further comprising:
receiving user input concerning a third spatial subunit in the spatial unit; and
configuring one or more of a fourth device, the third device, the first device, the second device, and the application system using at least one of the fourth rule and a fifth rule
wherein the fourth device is physically disposed in the third spatial subunit.

17. The method of claim 1 further comprising receiving a broadcast request from the first device prior to performing the determining.

18. The method of claim 1 further comprising receiving a user request for reconfiguring the first device before the determining.

19. The method of claim 1 further comprising:
determining an identifier of a provider of the first device based on a Media Access Control address associated with the first device; and
retrieving additional information concerning the first device using the identifier of the provider of the first device.

20. A configuration system for configuring at least one of a first device, a second device, and an application system, the application system utilized in a spatial unit, the spatial unit including at least a plurality of spatial subunits, the configuration system comprising:
a configuration script database configured to store various configuration scripts configuring for various devices;
an environment data database configured to store location data concerning devices already in the application system; and
a configuration unit configured to obtain a spatial subunit identifier associated with a first spatial subunit, the first spatial subunit related to the first device,
the configuration unit further configured to refer to the environment data database to determine that the second device is physically located in the first spatial subunit,
the configuration unit further configured to one or more of the first device, the second device, and the application system using at least a rule, the rule involving at least the first device and the second device.
